(19) United States
(12) Patent Application Publication
(10) Pub. No.: US 2011/0069756 A1
(43) Pub. Date: Mar. 24, 2011

(54) PREDICTIVE ENCODING/DECODING METHOD AND APPARATUS

(75) Inventor: Kim Matthews, Watchung, NJ (US)

(73) Assignee: ALCATEL-LUCENT USA INC., Murray Hill, NJ (US)

(21) Appl. No.: 12/564,969

(22) Filed: Sep. 23, 2009

(51) Int. Cl. H04N 7/32

(52) U.S. Cl. 375/240.12; 375/E07.243

(57) ABSTRACT

A predictive encoding/decoding method and apparatus in which the decoder signals available reference frames for use by the encoder for subsequent encoding.

### FIELD OF THE INVENTION

This disclosure relates to methods, devices, systems and networks employing predictive encoding and/or decoding.

### BACKGROUND

Technological developments that improve predictive encoding and/or decoding are of great interest due—in part—to the plethora of useful applications that employ such encoding/decoding.

### SUMMARY

An advance is made in the art according to an aspect of the present disclosure directed to predictive encoding/decoding methods and apparatus wherein a decoder indicates reference frames that may be used by an encoder for prediction based on their previously successful reception by the decoder. In sharp contrast to standard methods and apparatus that provided decoder feedback indicative of failed reception(s), the methods and apparatus of the instant disclosure provide decoder feedback indicative of successful reception(s). Consequently—and according to preferred implementations of the present disclosure—an encoder uses reference frames which are explicitly indicated as available at the decoder(s) and subsequently conveyed back to the encoder.

### BRIEF DESCRIPTION OF THE DRAWING

A more complete understanding of the present disclosure may be realized by reference to the accompanying drawings in which:

FIG. 1 is simplified block diagram showing an exemplary video predictive coding/decoding chain and exemplary video delivery via a network;

FIG. 2 is a simplified block diagram showing an exemplary series of predictively-encoded video frames with error;

FIG. 3 is a simplified block diagram showing a series of exemplary predictively-encoded video frames with error and subsequent reset via I-frame;

FIG. 4 is a simplified block diagram showing an exemplary video coding/decoding chain and exemplary video delivery via a network employing available reference frames according to an aspect of the present disclosure;

FIG. 5A is a simplified block diagram showing representative feedback delays encountered in a network;

FIG. 5B is a simplified block diagram showing representative feedback delays encountered in a network and one mechanism for improvement;

FIG. 6 is a simplified signal flow diagram showing exemplary video encoding/decoding and reference frame determination and notification according to an aspect of the present disclosure;

FIG. 7 is simplified signal flow diagram showing an alternative exemplary video encoding/decoding and reference frame determination and notification according to an aspect of the present disclosure;

FIG. 8 is a simplified block diagrams showing error persistence effects with prior techniques;

FIG. 9 is a simplified block diagrams showing error persistence effects with techniques according to an aspect of the present disclosure;

FIG. 10 is a simplified block diagrams showing a representative point-to-multipoint delivery system according to an aspect of the present disclosure;

FIG. 11 is a simplified block diagrams showing a representative point-to-multipoint delivery system and available reference frames according to an aspect of the present disclosure;

FIG. 12A shows an exemplary packet structure for a real-time transfer protocol (RTP) packet;

FIG. 12B shows an exemplary RTP packet header; and

FIG. 13 shows an exemplary video coding/decoding chain and video delivery/display and acknowledgements according to an aspect of the present invention.

The illustrative embodiments are described more fully by the Figures and detailed description. The inventions may, however, be embodied in various forms and are not limited to embodiments described in the Figures and detailed description

### DESCRIPTION

The following merely illustrates the principles of the invention. It will thus be appreciated that those skilled in the art will be able to devise various arrangements which, although not explicitly described or shown herein, embody the principles of the invention and are included within its spirit and scope.

Furthermore, all examples and conditional language recited herein are principally intended expressly to be only for pedagogical purposes to aid the reader in understanding the principles of the invention and the concepts contributed by the inventor(s) to furthering the art, and are to be construed as being without limitation to such specifically recited examples and conditions.

Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the diagrams herein represent conceptual views of illustrative structures embodying the principles of the disclosure. Furthermore, it will be appreciated that the exemplary scenarios—while generally shown as employing video—are not so limited. More particularly, those skilled in the art will readily appreciate the applicability of the present disclosure to a variety of applications involving predictive encoding including—but not limited to—audio applications, video applications, audiovisual applications, and other applications or combinations thereof. In the claims hereof any element expressed as a means for performing a specified function is intended to encompass any way of performing that function. This may include, for example, a) electrical or mechanical or optical elements which performs that function or combinations thereof, or b) software in any form, including therefore firmware, microcode or the like combined with appropriate circuitry for executing that software to perform the function, as well as optical and/or mechanical elements coupled to software controlled circuitry, if any. The invention as defined resides in the fact that the functionalities provided by the various recited means are combined and brought together in the manner which the claims call for. Applicant thus regards any means which can provide those functionalities as equivalent as those shown herein.

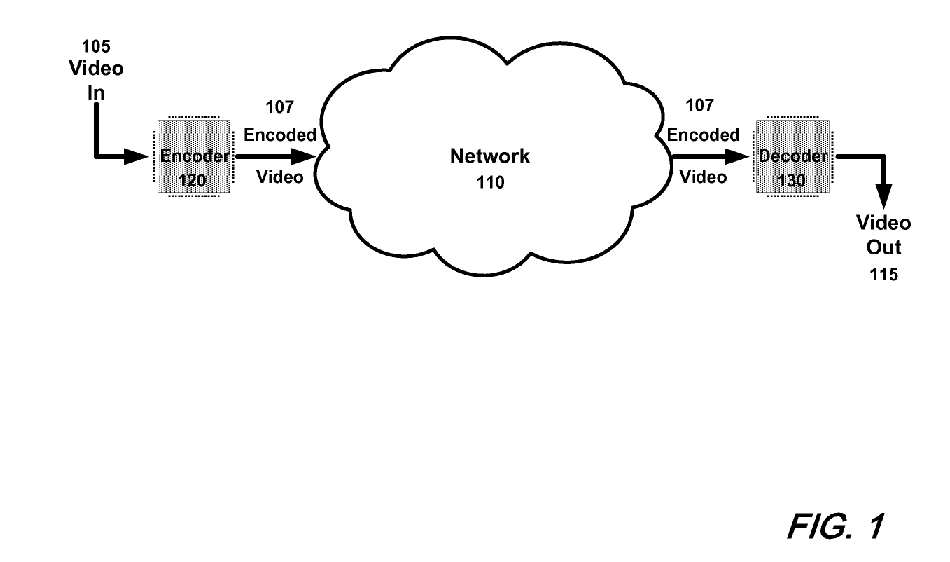

Turning now to FIG. 1 there is shown a schematic of a representative or exemplary video encoding/decoding “chain” and encoded video delivery via a network. In particular, at an originating (source) end a video encoder 120 processes an input video signal (stream) 105 such that an encoded video signal 107 is produced and output. The encoded video signal 107 is transmitted or otherwise conveyed via network 110 to a destination end where the encoded video signal 107 is received by a video decoder 130 which decodes the encoded video signal 107 producing an output video signal 115.

As may be appreciated by those skilled in the art, video encoding is generally the process of compressing raw video (for example, video in YCrCb format) into a bitstream that contains significantly less data than the raw video. Such encoding facilitates video transmission and/or storage.

Basic steps involved in video encoding are prediction, transform and quantization, and entropy encoding. Prediction takes advantage of spatial and temporal data redundancies in video frames to reduce the amount of data to be encoded. Transform and quantization further compress the data by applying mathematical techniques that express the energy in the predicted video as a matrix of frequency coefficients, many of which will be zero. Finally, entropy encoding substitutes binary codes for strings of repeating coefficients to achieve a final, compressed (encoded) video signal (bitstream). Video decoding reverses the process of encoding to generate uncompressed video for display or other use.

To facilitate the widespread adoption and utility of video encoding/decoding systems such as that shown in FIG. 1, a number of video coding standards have been developed and deployed industry-wide. For example, the MPEG-2 video encoding standard (also known as ITU-T H.262)—which was developed primarily as an extension of the prior MPEG-1 video encoding standard—was an enabling technology for the transmission of standard definition and high definition television signals over satellite, cable and terrestrial facilities as well as the storage of high-quality video signals on media such as DVDs.

Video encoding for telecommunications applications have evolved—for example—through the development of the ITU-T H.261, H.262 (MPEG-2), and H.263 video coding standards and later enhancements of H.263 known as H.263+ and H.263++, and most recently H.264. Such video encoding telecommunications applications have diversified from the Integrated Services Digital Network (ISDN) and T1/E1 services to Public Switched Telephone Networks (PSTN), mobile wireless networks and Local Area Networks (LAN)/Wide Area Networks (WAN)/Internet network delivery. Throughout this evolution, continued efforts have been made to improve encoding efficiency while accommodating diverse network types and their characteristic formatting and loss/error requirements.

With this foundation in place, the principles of the present disclosure will be described using—for example—an interactive videoconferencing scenario. Those skilled in the art will of course appreciate that the principles of the disclosure are not limited to videoconferencing. More particularly, it is envisioned that the present disclosure is equally applicable to other applications including but not limited to: broadcast over cable, satellite, cable modem, digital subscriber loop (DSL), terrestrial etc.; Interactive or serial storage on optical and magnetic devices, conversational services over ISDN, Ethernet, LAN, DSL, wireless and mobile networks, modems, etc., or mixtures thereof; video-on-demand or multimedia streaming services over ISDN, cable modem, DSL, LAN, wireless networks, etc; and multimedia messaging services over ISDN, DSL, Ethernet, LAN, wireless, and mobile networks, etc. Moreover, new applications may be deployed over existing and future networks which may advantageously employ one or more aspects of the present disclosure.

As may be appreciated, interactive video conferencing—and more generally, applications that involve video encoding, transmission, and decoding—utilize a number of different degrees of video compression as necessary. In a video sequence, individual frames are grouped together into a group of pictures or GOP and played back so that a viewer registers the video's spatial motion. An “I-frame” or “intraframe” is a single frame of digital content/video that is—in effect—a fully-specified picture. As such, it exhibits the least amount of compression when transmitted. Significantly, an I-frame is typically examined independently of any frames that precede it or follow it and contains all data necessary to display that frame.

A “P-frame” or “predictive frame” or predicted frame” frame typically contains only changes in the frame from the previous I-frame and subsequent P-frames. For example, a car moving across a stationary background may require only the car's movement to be encoded. Since P-frames follow I-frames they are consequently dependent upon the preceding I-frame for providing much of its frame data.

Lastly, a B-frame or “bi-directional frame” or “bi-directional predictive frame” is the most space saving frame of the types described as it uses differences between a current frame and both the preceding and succeeding frame(s) to specify its content. More particularly, B-frames contain data that have changed from the preceding frame or are different from the data in the succeeding frame.

In a representative implementation, I-frames are interspersed with P-frames and B-frames into an overall compressed video. As can be appreciated, by including more I-frames in the overall video, its error resilience and time-to-start decoding may be improved. However, I-frames contain the greatest number of bits and therefore consume the most bandwidth and/or storage.

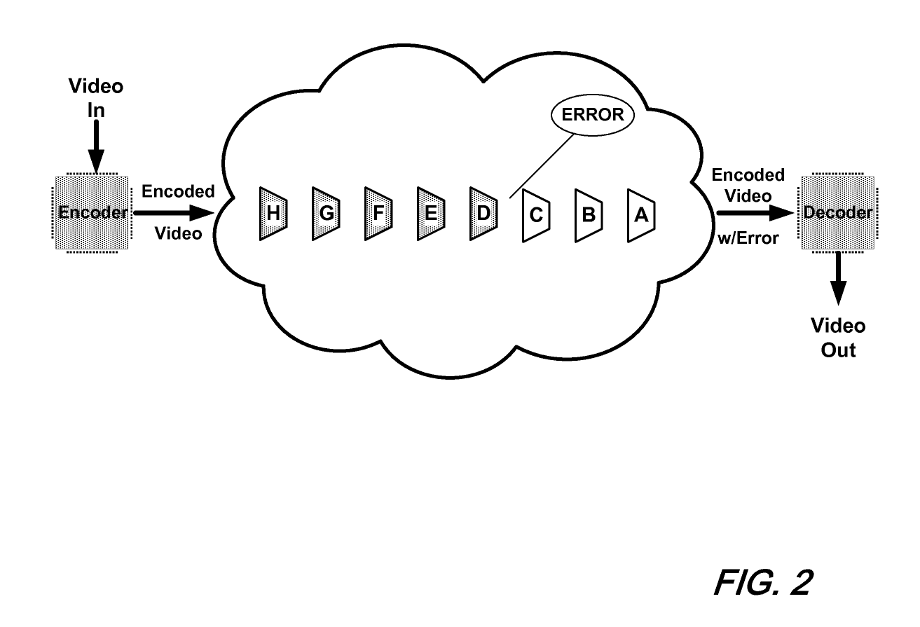

With reference now to FIG. 2, there is shown in simplified block diagram form, a series of predictively-encoded video frames (A, B, C, . . . , F, G, H) being transmitted over a telecommunications network such as that previously shown and described. As shown further in FIG. 2, it is assumed that an error occurs during the transmission of frame D which may be due—for example—to any of a variety of possible transmission errors within the network. Consequently, when that frame D is decoded by the decoder, the error so introduced will be propagated to all subsequent frames (E, F, G, . . . ) during their decoding by the decoder (reconstruction)—as shown by their shading. As can be generally appreciated—in predictive encoding systems such as the one shown—an error in the communication between the encoder and the decoder will result in the persistence of that error at the decoder until the prediction is turned off or otherwise reset/refreshed.

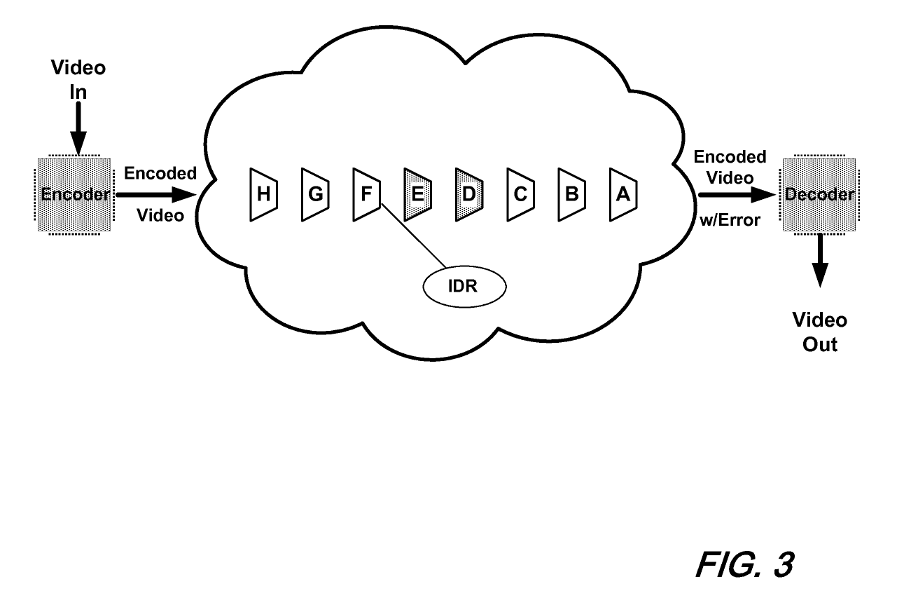

Consequently—and with reference now to FIG. 3—it may be observed that this persistent (or propagating) error may be turned off by the transmission of an I-frame (IDR frame). The transmission of an I-frame effectively “resets” or “refreshes” the prediction, thereby eliminating the persistence of this error. As shown in the example depicted in FIG. 3, an error initially in frame D propagates (persists) while decoding through frame E, until the prediction is refreshed (reset) by frame F (IDR frame).

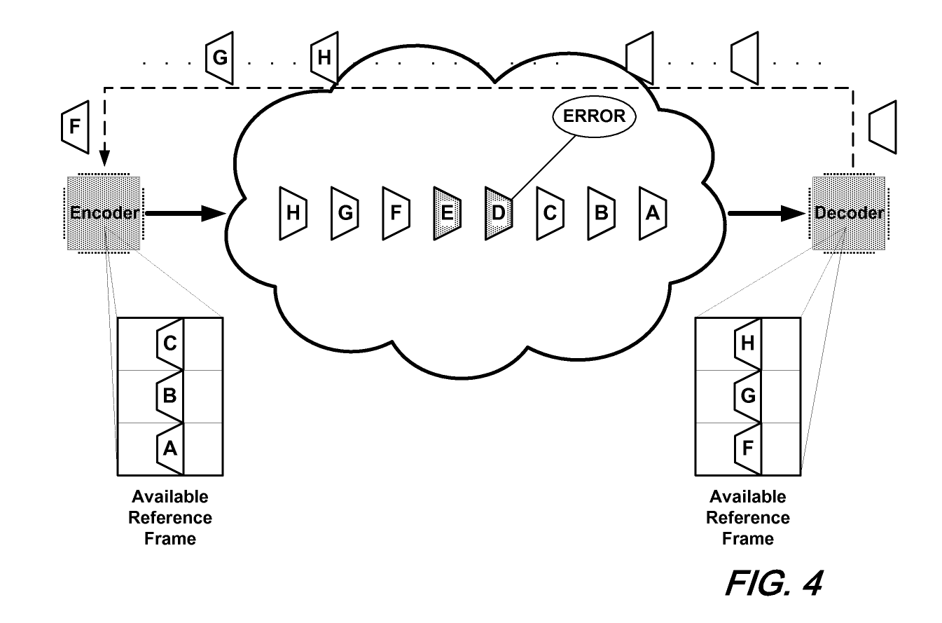

Turning now to FIG. 4, there is shown a block diagram depicting an exemplary video coding/decoding chain and delivery via a network wherein the encoder and decoder employ available reference frames according to an aspect of the present disclosure.

As shown therein, a series of frames are predictively-encoded by the encoder and transmitted via the network to a decoder where they are subsequently decoded. For the purposes of this example, a propagating error is shown in frames D and E.

Upon receipt by the decoder, the encoded frames are decoded. When a frame is successfully decoded (or it can be determined as such—i.e. by/at the decoder's receiver), an acknowledgement is sent back to the encoder and a list of available reference frames is updated within the decoder. For example, when encoded frame A is received by the decoder and successfully decoded (or determined as such), an acknowledgement is conveyed back to the encoder indicating that frame A is available to use as a reference frame. In addition, a list of available reference frames—maintained by the decoder—is updated to reflect the successful decoding and availability of this frame A as a reference.

Similarly—by the encoder—a list of available reference frames is maintained which indicate which frames were determined at the decoder to be suitable references and therefore available as encoder references. Accordingly, as the acknowledgements are transmitted from the decoder and received by the encoder, the reference frame (or representation thereof) associated with that acknowledgement is added to the list of available reference frames maintained by the encoder.

Returning to the example shown in FIG. 4, the overall operation of a method and apparatus according to the present disclosure may be more readily understood.

As coded frames A, B, C, D, E, F, G, and H are received by the decoder, they are decoded in the order in which they are received. So, as coded frame A is received and successfully decoded by the decoder, an acknowledgement of frame A is transmitted back to the encoder. Note that this acknowledgement may constitute any of a number of indications. The general purpose of the acknowledgement is to provide an indication to the encoder that frame A was or will be successfully decoded by the decoder and as such is now an available reference frame.

As shown in FIG. 4, the decoder maintains a list of available reference frames. It is notable that this “list” may be of any of a variety of data structures and the use of the term list is in no way restrictive. Those skilled in the art will of course appreciate that data structures useful for such purposes may include, for example, scalars, vectors, arrays, lists, linked lists or stacks, to name a few.

This process of decoding/acknowledgement will generally continue by the decoder until an error (frames D and E) prevents frames from being successfully decoded. Since these frames are not/will not be successfully decoded, no acknowledgement is sent for these frames and they are not maintained in the list of available reference frames by the decoder.

Similarly, as an acknowledgement of an available reference frame is received by the encoder, the encoder updates its list of available reference frames. Accordingly, as the encoder encodes a given frame, it may generally use as a reference—the reference frame most recently acknowledged and subsequently maintained in its list of available reference frames. It is worth noting at this point that in a system according to the present disclosure the decoder could also signal the encoder which frame(s) are not/will not be successfully decoded. As such, an acknowledgement signal may take the form of actively notifying the decoder which particular frame(s) are not/will not be successfully decoded. Those skilled in the art will readily appreciate that a variety of alternative encoder operation(s) are made possible by this enhanced feedback operation. More particularly, it may permit an encoder to “know” a-priori which types of frames are subject to failure and use that information to more favorably apply any prediction. That is to say, predictively-preempt their failure during transmission.

As shown in FIG. 4, the encoder's most recently received reference frame is frame C as indicated by its position in the available reference frame list. Upon receipt by the encoder of the acknowledgement for frame F—for example—the available reference frame list for the encoder will be updated to include frame F as an available reference frame. As a result, frames encoded by the encoder after receipt of the frame F acknowledgement may be so encoded using frame F as reference.

At this point those skilled in the art will appreciate that it is the decoder that defines available reference frames which the encoder may subsequently use.

Operationally, as video frames are encoded by the encoder, transmitted via the network, and received/decoded by the decoder, the decoder will maintain a list (history) of video frames to use as available reference frames. The decoder will feedback to the encoder information identifying currently available reference frames for encoder use. In one exemplary embodiment, the encoder may preferably use the most recent reference frame known to be available at the decoder as a predictor to encode subsequent video frames.

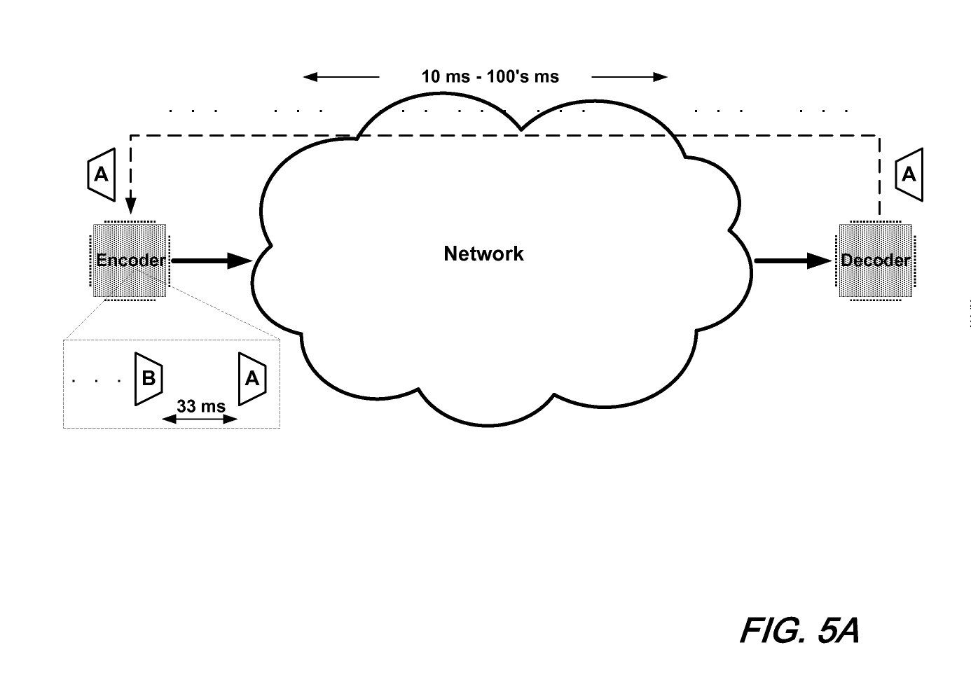

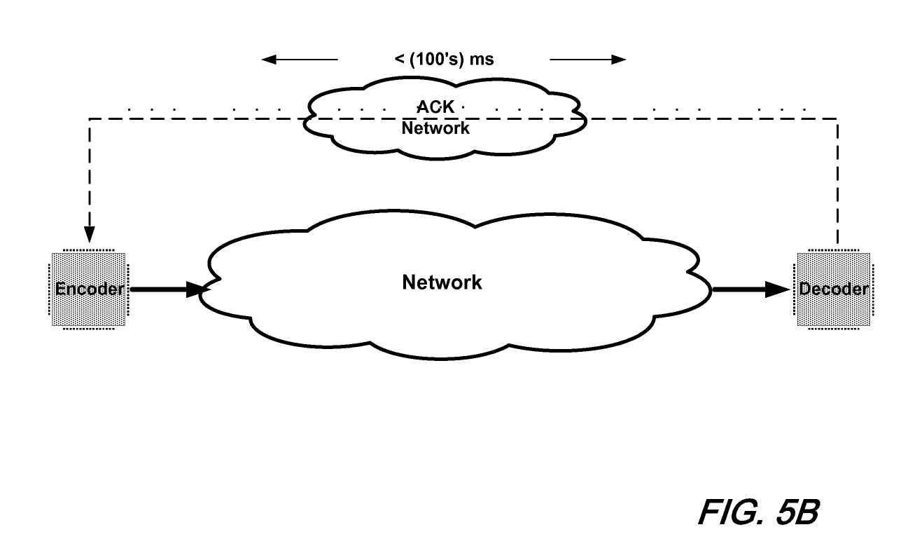

As noted previously, I-frames require more bits for transmission than other frames. As a result, contemporary video encoding/decoding systems employ a compressed picture frame buffer (CPB) to smooth the transmitted bit rate. Unfortunately, buffering produces additional latency between frame-in and reconstructed frame-out times. One problem resulting from this additional latency may be understood with reference to FIG. 5A.

With reference to that FIG. 5A, there is shown a simplified block diagram of an encoder/decoder pair interconnected via telecommunications network. As before, video frames encoded at the encoder are transmitted via the network to the decoder, where they are subsequently decoded. While not specifically shown, a buffer—such as a CPB previously noted—is used in the encoder to smooth the transmission bit rate.

As can be appreciated, the elapsed time from completing the encoding of a particular frame to the beginning of the encoding of a next frame is very short. In this example, it is shown as the time between frame A and frame B and is only ˜33 msec. Unfortunately, the feedback (acknowledgement) time from the decoder end to the encoder end can substantially much longer than the 33 msec. For example, while over a local area network (LAN) a round trip feed back time may only be 10 ms or so, the round trip feed back time over a wide area network (WAN) may be 100's of msec. Consequently, a large number of erroneous frames may be sent from the encoder to the decoder even after the detection of an error at the decoder end. Advantageously, this problem is substantially mitigated by methods according to the present disclosure.

Turning now to FIG. 5B there is shown an alternative network configuration which may advantageously improve the round trip feed back time. As can be appreciated by those skilled in the art, the feedback (acknowledgement) does not have to utilize the same network as that transporting the encoded video. As shown in exemplary FIG. 5B, the feedback (acknowledgement) network may be a physically distinct network. For example, encoded video may be transmitted via a satellite link, while the feedback network may be terrestrial (or combinations of terrestrial and over-the-air). In this manner, while the time(s) required to transport the encoded video may be lengthy (in relative terms) due to the transport delay(s) associated with the particular network technologies used, the return acknowledgements may advantageously be substantially shorter and an overall improvement in round trip time(s) may be observed. In the example shown, the return trip is shown to be better than the 100's ms which may be encountered in practice.

Notably, the H.264 standard includes a number of new features not available in prior standards that allow it to compress video more effectively than the older standards that it supersedes. One such feature is the utilization—by the encoder—of a number of previously-encoded pictures as references. This allows for modest improvements in bit rate and quality in most scenes. In certain types of scenes, such as those with repetitive motion, it allows a significant reduction in bit rate while maintaining an acceptable clarity. Operationally, the encoder will send a reference frame followed by one or more P-frames in sequence until a cut or scene change at which time it (the encoder) will send another reference frame and the whole process repeats. As will be shown and described, these new features of the H.264 standard when coupled with the teachings of the present disclosure provide significant improvements in overall encoding/decoding efficiency and transmission performance.

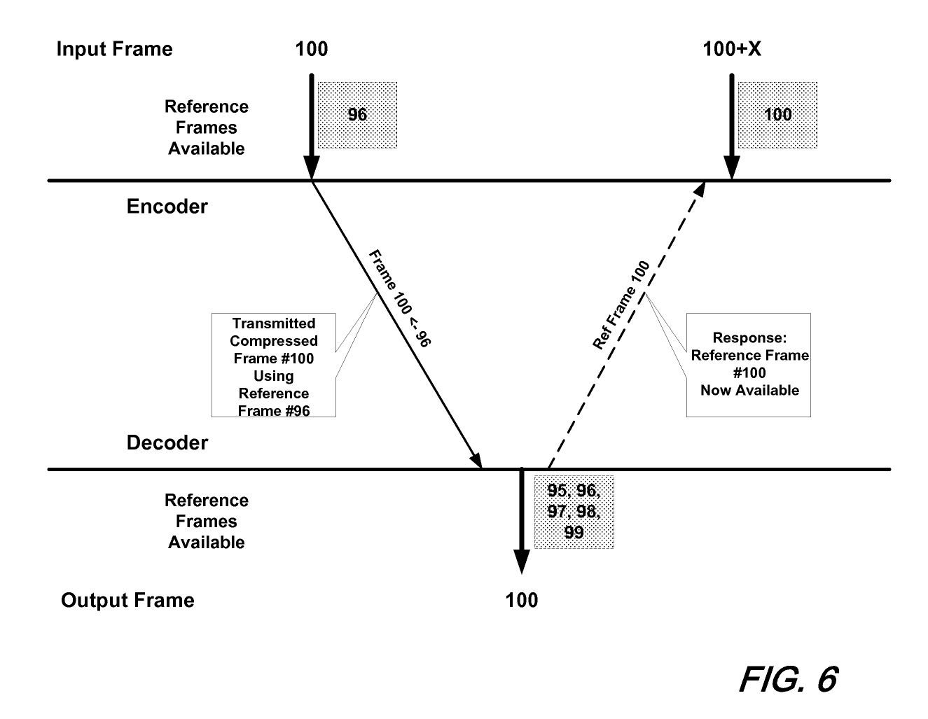

With reference now to FIG. 6, there is shown a simplified signal flow diagram depicting an example encoding/decoding, and reference frame determination and notification according to an aspect of the present disclosure. According to the example shown, at a given point in time, an encoder (not specifically shown) will receive an input frame (#100) for encoding. At the time of receipt, a reference frame (#96) is available to that encoder for use as a reference. As a result, the encoder will encode input frame #100 using information predicted from reference frame #96.

The encoded frame #100 (encoded according to reference frame #96) is transmitted via a network (not specifically shown) to a decoder (not specifically shown). The decoder will—upon receipt of the encoded frame #100—decode that frame and if successful (or determined that it will be successful) will thereby produce an output frame #100.

As can be observed in FIG. 6, when the decoder decodes frame #100 it has maintained a list of available reference frames. In particular, at the time frame #100 is decoded, the list of available reference frames includes—for example—frames 95, 96, 97, 98, and 99.

Upon the successful decoding of frame #100, the decoder provides a feedback acknowledgement signal to the encoder, indicating that reference frame #100 is now available. Accordingly, upon receipt of that feedback acknowledgement signal, the encoder may use reference frame #100 to encode a later input frame. In this example, that later input frame #100+x is shown being encoded using reference frame #100.

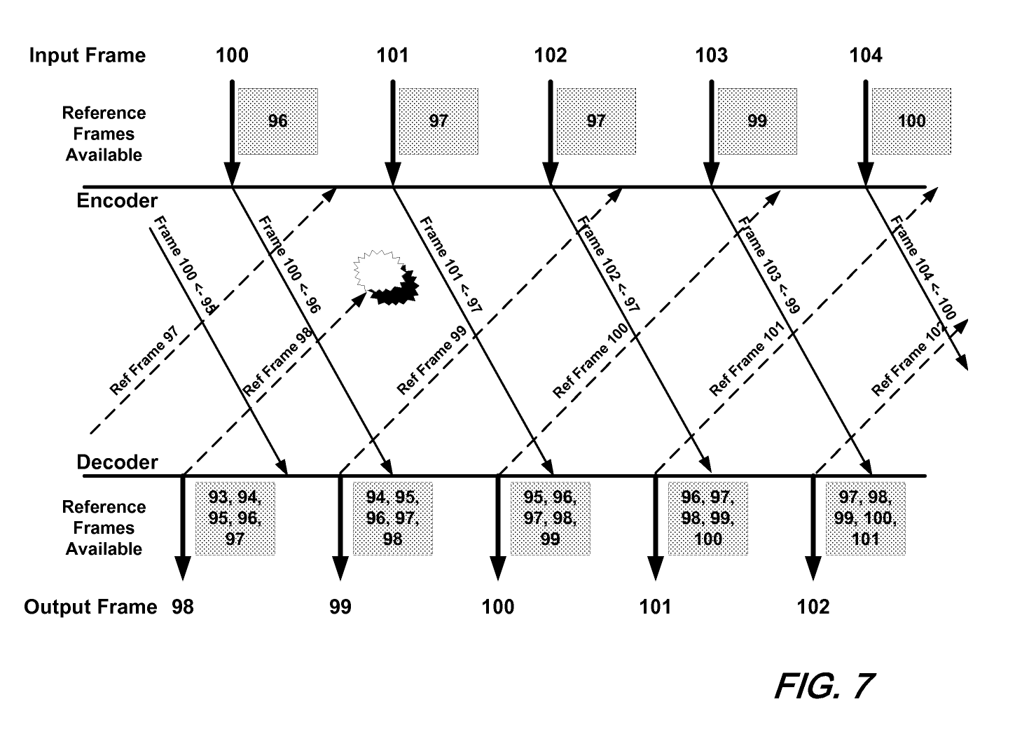

A more comprehensive signal flow example is shown in FIG. 7. More particularly, FIG. 7 shows the encoding of a number of input frames, their decoding and resulting output frames produced, as well as the reference frame(s) available at the encoder and decoder at various times.

A review of the diagram shown in FIG. 7 may conveniently begin at its leftmost portion, by observing that a feedback acknowledgement signal indicating that reference frame #97 is an available reference frame is sent from the decoder to the encoder. While that acknowledgement is being transmitted and subsequently traversing the network (not specifically shown), output frame #98 is generated by the decoder. At the time that frame #98 is decoded, the decoder has maintained a list of a number of reference frames including #93, #94, #95, #96 and #97. Since this frame #98 is decoded correctly, the decoder—according to the present disclosure—transmits (feeds back) an acknowledgement signal to the encoder indicating that this frame #98 is now an available reference frame. Subsequently, the decoder adds to its available reference frame list an indication that frame #98 is an available reference frame.

Note that the feedback acknowledgement signal indicating that frame #98 is an available reference frame sent from the decoder to the encoder encounters—for example—a transmission error or other difficulty and consequently never reaches the encoder as intended. As a result—and as will be described in more detail later—that frame #98 will never be used by the encoder as a reference frame—in this example.

Continuing, when input frame #100 is encoded by the encoder, its available reference frame is #96. Input frame #100 is so encoded and transmitted to the decoder. At some time thereafter, encoded frame #99 is received by the decoder and decoded thereby producing output frame #99. At the time output frame #99 is decoded, the decoder list of available reference frames includes #94, #95, #96, #97 and #98. Since frame #99 was successfully decoded, an acknowledgement indicating that this frame #99 is now an available reference frame is transmitted from the decoder to the encoder and reference frame #99 is added to the decoder's available reference frame list.

When input frame #101 is encoded by the encoder, the encoder has already received notification (acknowledgement) from the decoder that reference frame #97 is an available reference frame. As a result, the encoder's list of available reference frames is so indicative, and the encoder encodes input frame #101 using reference frame #97 and transmits that encoded frame #97 to the decoder.

Accordingly this process generally repeats as time progresses. It is useful however, to observe that while input frame #102 was encoded using reference frame #97, input frame #103 was encoded using reference frame #99. Recall for a moment that the acknowledgement notification sent from the decoder to the encoder indicating that reference frame #98 was available as a reference frame was never received by the encoder. As a result, the encoder uses as an available reference frame #97 and then reference frame #99. Reference frame #98 is never used by the encoder because its availability was never received.

Advantageously, there is no need for either the encoder or decoder to re-transmit or otherwise correct this transmission error. As long as the encoder uses the latest reference frame that it knows is available, and the decoder keeps a list of available reference frame(s), then the overall process proceeds without significant performance-affecting incident.

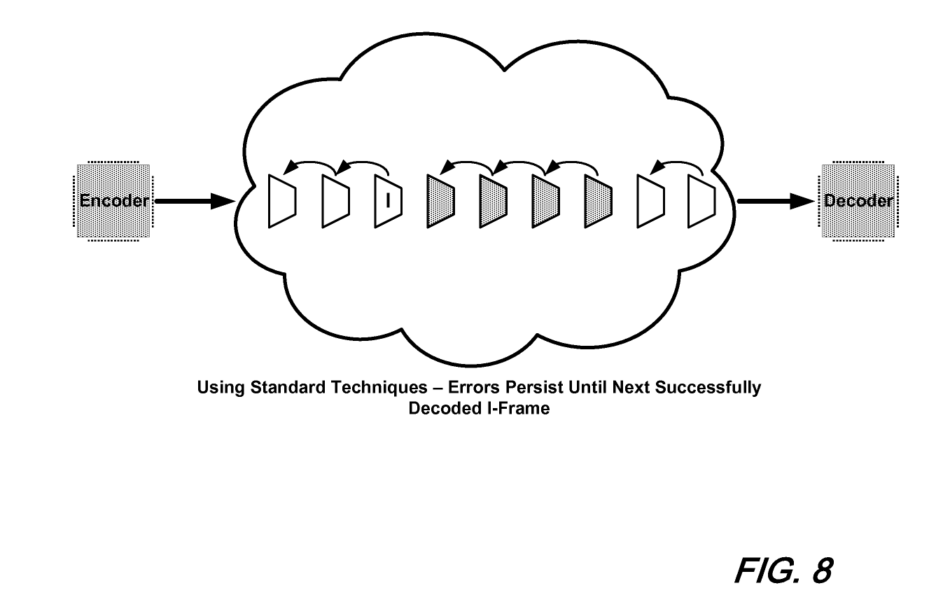

At this point certain advantages of a method according to present disclosure may become readily apparent. With reference now to FIG. 8, there is shown a block diagram depicting a series of frames transmitted from an encoder to a decoder. As with a number of the other examples already shown, when an error occurs during transmission, that error will persist in successive frames, as those frames are decoded by the decoder. More particularly, these standard techniques result in errors persisting until a successive I-frame is received. Accordingly, errors affect a frame with the error, and persist in subsequent frames unless and until an I-frame is sent to reset or refresh the prediction.

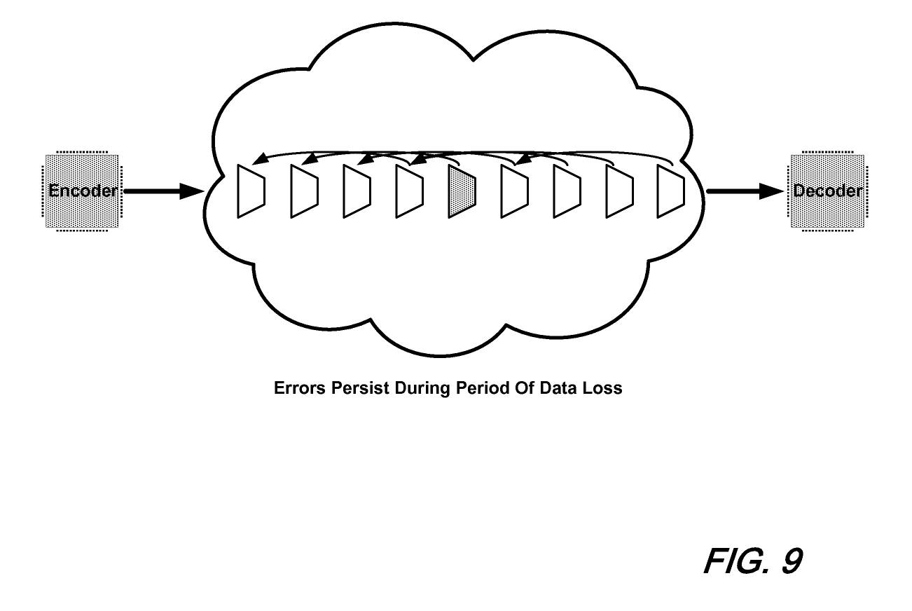

Turning now to FIG. 9, there is shown a block diagram depicting a series of frames transmitted from an encoder to a decoder according to an aspect of the present disclosure. In sharp contrast to the scenario shown in FIG. 8, the effects of errors are reduced. More particularly, even though the system is predictive, errors may only affect the frames which are incorrectly sent.

Those skilled in the art may now further appreciate methods and apparatus implemented according to the present disclosure. More particularly, and in sharp contrast to standard (or prior art) methods and apparatus that provide decoder feedback indicative of failed reception(s), the methods and apparatus according to the present disclosure provide decoder feedback indicative of successful reception(s). Consequently—in preferred implementations of the present disclosure—an encoder uses reference frame(s) which are explicitly indicated as available at the decoder(s) and subsequently conveyed back to that encoder. Consequently, the encoder will make predictions only from frames that have been confirmed to have been received correctly by the decoder. In this inventive manner, encoder and decoder “prediction loops” are synchronized and no I-frames are required to be transmitted. As a result, the method advantageously allows the CPB to be reduced in size and any latencies between encoding and decoding may be significantly reduced. Finally, the persistence of errors visible at the decoder will be limited to the number of frames transmitted during a network interruption.

In sharp contrast, schemes that provide negative acknowledgement(s) from failed reception(s) signal that a frame did not arrive correctly, so any I-frame predictions based upon errored frames will continue to be made until the negative acknowledgement is received. As can be appreciated, the minimum time for such negative acknowledgement to be received by the encoder will be a measure of the round-trip delay of the network. Such a round-trip time may be quite long and during which every transmission error will result in error(s) in transmitted images. Additionally, because such schemes require that a bad frame be negatively acknowledged, if such negative acknowledgement is lost in transmission—say, due to network congestion—then the encoder and decoder will not resynchronize from the prediction until an I-frame is transmitted. Consequently, a 100% reliable negative acknowledgement delivery mechanism is necessary, or the encoder will still be required to encode I-frames periodically. This of course, requires a larger CPB buffer and produces an increased end-to-end latency.

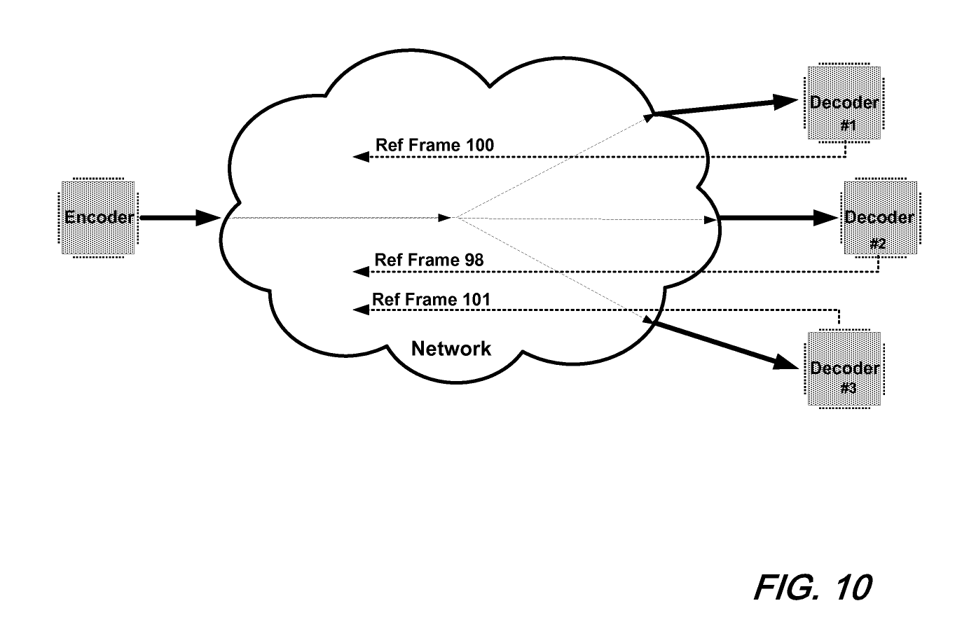

Turning now to FIG. 10, there is shown a simple diagram depicting a point to multipoint scenario according to yet another aspect of the present disclosure. In particular, a single source encoder is shown broadcasting or otherwise transmitting—for example—an encoded video stream to a number of receiving decoders via a network.

More particularly the encoder encodes any source data and transmits (multicast) that encoded data to the three decoders namely, decoder #1, decoder #2, and decoder #3. And while this example (point-to-multipoint) is shown with only three multipoints (decoders), those skilled in the art will quickly appreciate that this scenario may be extended out to any number of decoders—subject to network limitations.

As shown further in this FIG. 10, each of the individual decoders provide feedback acknowledgement to the encoder regarding available reference frames which were (or may be) successfully decoded at the particular decoder. As can be appreciated, since each of the decoders may likely involve a distinct network path or access/egress path between the individual decoder and the encoder, an error may affect an individual decoder while not affecting one or more of the others Additionally, different network latencies may result for one or more of the decoders thereby permitting some decoder(s) to effectively acknowledge sooner than other(s).

As such, each individual decoder maintains an individual list of available reference frames which may or may not be the same as another decoder's list of available reference frames. For example, FIG. 10 shows that decoder #1 has acknowledged reference frame #100 decoder #2 has acknowledged reference frame #98, while decoder #3 has acknowledged reference frame #101.

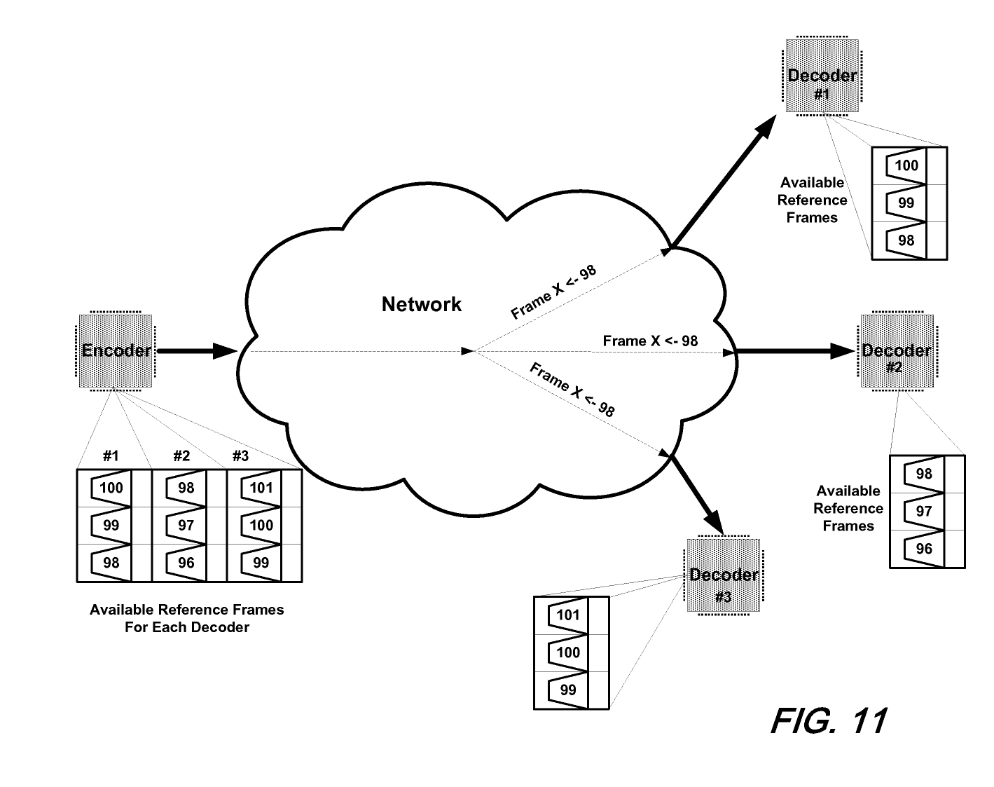

With simultaneous reference now to FIG. 11, there is shown a more detailed view of the network scenario presented in FIG. 10. More particularly, it is shown that decoder #1 maintains a list of available reference frames and—as shown in this example—that list includes reference frames #100, #99, and #98. Similarly, decoder #2 maintains a list of available reference frames which now includes reference frames #98, #97, and #96. Finally, decoder #3 maintains a list of available reference frames which includes reference frame(s) #101, #100, and #99.

Recall for a moment that according to an aspect of the present disclosure, it is the decoder which determines and subsequently signals/indicates available reference frames for the encoder to use while performing subsequent encodings. As shown in FIG. 10 and continued in FIG. 11, each of the decoders has provided to the encoder a different reference frame. As such, if the encoder were to use the most recent reference frame for each particular decoder, the advantages of the point-to-multipoint network operation would be lost.

Accordingly, and according to yet another aspect of the present disclosure, the point-to-multipoint encoder maintains a list of available reference frames for each decoder, yet transmits encoded data using the “latest common” or “most recent common” reference frame.

This operation may be understood with continued reference to FIG. 11. As shown therein, the encoder maintains a list of available reference frames for each decoder involved in the point-to-multipoint operation. For example, decoder #1 is shown in the encoder table as having available reference frames #100, #99, and #98. Similarly, decoder #2 is shown in the encoder table as having available reference frames #98, #97, and #96. Finally, decoder #3 is shown as having available reference frames #101, #100, and #99.

Since—with this example—the most recent common reference frame for all three decoders involved in this point-to-multipoint scenario is reference frame #98, subsequent encoded transmissions for this point-to-multipoint group may be sent using this preferred reference frame #98 as shown in FIG. 11. The list of available reference frames is checked by the encoder prior to encoding for all subsequent encodings, and—in this example—the most recent common frame is used as a reference. As can be appreciated—and for the sake of example only—if this transmission of frame X is successfully decoded by the three decoders, then upon acknowledgement of that fact and receipt thereof by the encoder along with update of the available reference frame list(s), the encoder may use this frame X as a next most recent common reference frame.

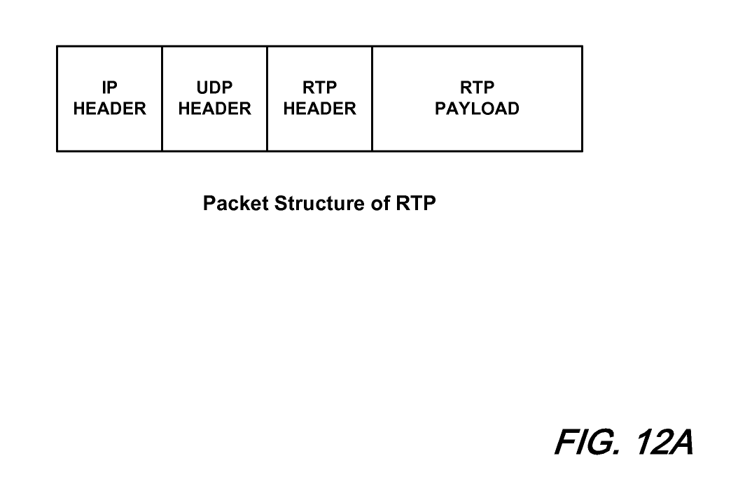

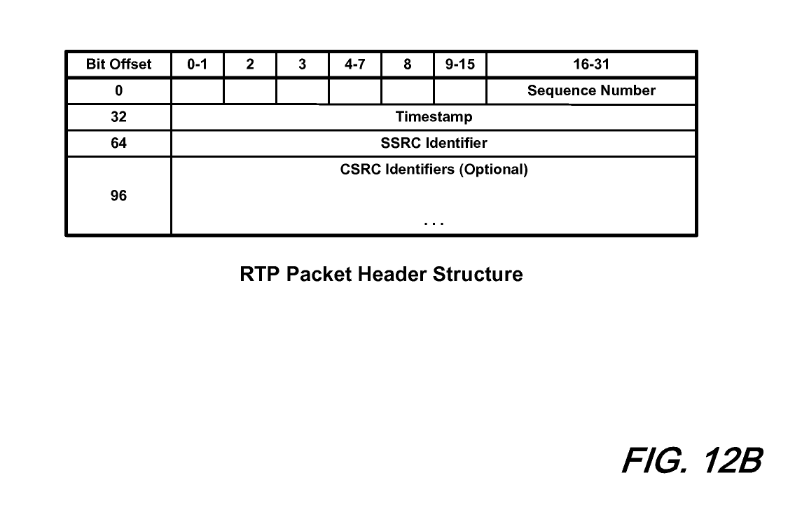

Turning now to FIG. 12A and FIG. 12B, there is shown an exemplary real-time transfer protocol (RTP) packet (FIG. 12A) and header (FIG. 12B) which may be advantageously employed according to an aspect of the present disclosure. As may be known by those skilled in the art RTP is a protocol that is useful to provide end-to-end delivery services of data (such as interactive audio/video i.e., videoconferencing) with real-time characteristics.

As shown in FIG. 12A the RTP packet includes a number of fields. The real-time media (i.e., audio-visual) transported forms the RTP payload. The RTP header contains information related to the payload, i.e. source, size, encoding type, etc. To transport the RTP packets, they are generally transported as part of a User Datagram Protocol (UDP). To transport the UDP packets over an Internet Protocol (IP) network for example, the UDP packets (with RTP packets) are encapsulated with an IP packet—which may be transported within other packets (not specifically shown).

FIG. 12B shows a schematic RTP header which may be advantageously used with methods and apparatus according to aspects of the present disclosure. Of particular interest for such methods and apparatus are the sequence number and timestamp fields. The sequence number field is generally incremented by one for each successive RTP packet transmitted and may be used by a receiver to detect packet loss and/or to restore packet sequence. The timestamp reflects a sampling instant of the first octet in the RTP data packet. The sampling instant is generally derived from a clock that increments monotonically and linearly in time to allow synchronization and jitter calculations.

Operationally, the RTP itself does not dictate any particular action when a packet is lost or corrupt. Instead, it is left to an application or other mechanism to take any appropriate action(s). For example, video application may play a last known frame in place of a missing frame. As can be appreciated, RTP provides no guarantee of delivery, but the presence of sequence numbers makes it possible to detect missing packets.

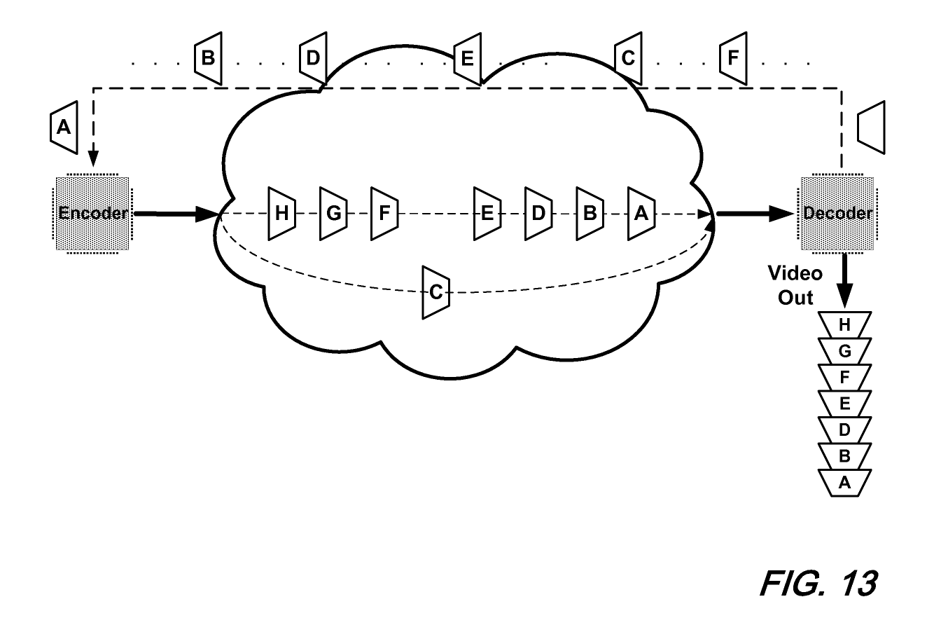

One particularly distinguishing aspect of method(s) and/or apparatus constructed according to the teachings of the present disclosure will become apparent with reference to FIG. 13 and continued recollection of the RTP structures described above. Turning now to that FIG. 13, there is shown a simplified block diagram of an encoder/decoder pair interconnected via telecommunications network.

As described previously in this disclosure, video frames encoded at the encoder are transmitted via the network to the decoder, where they are subsequently received/decoded and output. As individual frames are received and a determination is made as to their suitability to be used as available reference frame(s), an acknowledgement to that effect is relayed back to the encoder, where it may be used as indication of available reference frames for subsequent encoding.

Generally, when a sequence of frames is sent from encoder to decoder, the sequence number (see, e.g., the RTP structure described above) is incremented at the encoder end of the transmission. Consequently, as frames are received by the decoder end, an examination of the sequence number may be used to determine whether frames have been lost in transmission. Accordingly, while a decoder end may attempt to receive/decode/display a series of frames in an appropriate sequence number, that may not be possible at times because particular frames were lost or rendered unusable during transmission.

It may be observed with reference to FIG. 13 that the network shown therein may provide a number of distinct paths from encoder to decoder. Accordingly, even though the encoder sequentially encodes individual frames and launches them into the network with appropriate sequence numbers, certain frame(s) may arrive at the decoder end out of sequence because—for example—they took a different path through the network.

More specifically, and as shown in FIG. 13, frames A, B, C, . . . F, G, and H are all encoded, sequenced, and launched into the network for transport to the decoder end. As shown further in this FIG. 13, frame C is shown taking a different network path than the other frames A, B, D, . . . F, G, and H. As a result—and for the purposes of this example only, it arrives at the decoder end after frames D and E.

Assuming, for the sake of this simple example, that any output buffer(s) or other mechanisms employed by the decoder are insufficient to hold/maintain a suitably large number of output frames, it may be necessary for the decoder to skip over this delayed frame C and instead play/output the frames it received in sequence. As shown, in this example, the video out from the decoder is shown to be frames A, B, D, . . . E, F, G, and H. Due to its delay in transmission/reception, frame C is not included in the output stream.

Notwithstanding this however, and according to an aspect of the present disclosure, since frame C was received and capable of being decoded (albeit not output as video due to its delay and/or other limitations such as buffer size, etc) the decoder will nevertheless determine that frame C is an available reference frame and provide indication to that effect back to the encoder as shown in FIG. 13. Consequently, and according to this aspect of the present disclosure, available reference frames may advantageously include those frames which are not actually output as video (in this example) by the decoder,

Stated alternatively, even if a frame is not used (or useful) for display because—for example—a packet was delayed/re-routed, etc., making it too late to use, it may still be determined to be an available reference frame and acknowledged and added to the lists of available reference frames at the decoder and encoder. As such, it will be a potential frame to be predicted from (thereby potentially improving image quality during periods of congestion) at/by the encoder. Accordingly, a method according to this aspect of the present disclosure could/should be unaffected by network delivery times and ordering and that all frames that arrive completely and correctly (or are determined to be so) could/should be acknowledged and decoded and noted to be available reference frames for subsequent encoding.

It is useful to note that while the discussion so far has been focused on the explicit acknowledgement of every available reference frame, those skilled in the art will appreciate that the inventive teachings of the instant disclosure are not so limited. More particularly, it may be advantageous in certain situations to explicitly acknowledge blocks of available reference frames instead of individual ones. In this manner, the block acknowledgement may serve as explicit acknowledgement of the availability of all frames within the block to be available reference frames.

At this point, while we have discussed and described the invention using some specific examples, those skilled in the art will recognize that our teachings are not so limited. Accordingly, the invention should be only limited by the scope of the claims attached hereto.

1. A method comprising the steps of:
receiving by an encoder a set of data to be encoded; and
predictively encoding the data based on a reference frame identified to the encoder by a decoder as an available reference frame.

2. The method of claim 1 further comprising the steps of:
outputting the predictively encoded data.

3. The method of claim 2 further comprising the step of:
receiving by the encoder an indication of a reference frame which is available to be used for encoding wherein said reference frame indication is provided by the decoder.

4. The method of claim 2 further comprising the steps of:
receiving by the encoder a plurality of reference frame indications sent to the encoder from a plurality of decoders; and
predictively encoding the data using a selected one of the reference frame indications.

5. The method of claim 4 wherein said selected one of the reference frame indications is indicative of the most recent common reference frame.

6. The method of claim 4 further comprising the steps of:
maintaining by the encoder a plurality of lists of available reference frames, one list for each one of the plurality of decoders.

7. A method comprising the steps of:
receiving by a decoder a set of encoded data;
decoding the data; and
identifying by the decoder an available reference frame for use by an encoder.

8. The method of claim 7 further comprising the steps of:
conveying by the decoder to the encoder an indication of the availability of the reference frame.

9. The method of claim 8 further comprising the step of:
maintaining by the decoder a list of available reference frames.

10. An apparatus comprising:
means for receiving an encoded bitstream;
means for determining an available reference frame for use by an encoder; and
means for conveying an indication of the available reference frame to the encoder.

11. The apparatus of claim 10 further comprising:
means for maintaining a list of available reference frames.

12. An apparatus comprising:
means for receiving a bitstream for encoding;
means for maintaining a list of available reference frames indicated by a decoder; and
means for encoding the bitstream based upon the list of available reference frames indicated by the decoder;

13. The apparatus of claim 12 further comprising:
means for maintaining a plurality of lists of available reference frames as indicated by a plurality of decoders; and
means for determining a particular reference frame to use for encoding wherein the indication of that particular reference frame is included in one or more of said plurality of lists.
